(19) United States
(12) Patent Application Publication
(10) Pub. No.: US 2026/0336077 A1
(43) Pub. Date: Oct. 29, 2026

(54) REVERSE TORQUE SUPPRESSION DEVICE FOR POWER TOOL

(71) Applicant: PEI-LUN WEI, New Taipei City (TW)

(72) Inventor: PEI-LUN WEI, New Taipei City (TW)

(21) Appl. No.: 19/189,275

(22) Filed: Apr. 25, 2025

(51) Int. Cl. B25B 23/147

(52) U.S. Cl. CPC B25B 23/147

(57) ABSTRACT

A reverse torque suppression device for a power tool includes a transmission unit with a spindle, a magnetic force generation unit passing through the spindle and having a stop surface with a first positioning portion, and a driven unit fitted on the spindle. The spindle is rotatable relative to the magnetic force generation unit. The driven unit faces the stop surface, is movable between a first position and a second position along the spindle relative to the magnetic force generation unit, and includes a second positioning portion. When the driven unit is at the first position, the second positioning portion is disengaged from the first positioning portion. When the magnetic force generation unit generates an attractive magnetic force, the magnetic force generation unit moves the driven unit to the second position, and the second positioning portion and the first positioning portion are engaged to restrict a rotation of the spindle.

### BACKGROUND OF THE INVENTION

### Technical Field

The present invention relates generally to power tool technology, and more particularly to a reverse torque suppression device for a power tool.

### Description of Related Art

It is known that conventional power tools, such as electronic torque screwdrivers without a clutch mechanism or electronic torque wrenches, allow a user to set a torque value and use the user-defined torque setting to tighten screws, nut, and other workpieces. When the torque applied to the workpiece reaches the user-defined torque setting, a motor of the power tool immediately stops rotating. Therefore, the workpiece is tightened to the user-defined torque setting.

However, during the process of tightening the workpiece, the user must apply a force to counter a rotational force generated by the power tool to maintain the stability of holding the power tool. As the torque required for tightening the workpiece increases, a reaction force exerted on the hands of the user also increases. When the workpiece is tightened by the power tool, the motor of the power tool stops transmission. As no clutch mechanism is provided between the motor and a spindle, the motor could not stop the spindle of the power tool from rotating, so that the spindle has a rotational inertia. As a result, the power tool could not immediately absorb a rotational reaction force after tightening the workpiece, and the user is required to apply an additional force to control the power tool, resulting in discomfort or fatigue of the wrist upon prolonged use.

Therefore, the convention power tools still have room for improvement.

### BRIEF SUMMARY OF THE INVENTION

In view of the above, the primary objective of the present invention is to provide a reverse torque suppression device for a power tool, which could reduce the discomfort when the user uses the power tool to tighten a workpiece.

The present invention provides a reverse torque suppression device for a power tool, including a transmission unit, a magnetic force generation unit, and a driven unit. The transmission unit has a spindle. The spindle is provided with a sliding section. The magnetic force generation unit passes through the spindle. The spindle is rotatable relative to the magnetic force generation unit. The magnetic force generation unit has a stop surface. The stop surface is provided with a first positioning portion. The driven unit is fitted on the sliding section of the spindle and faces the stop surface of the magnetic force generation unit. The driven unit is capable of being driven by the spindle to rotate. The driven unit is movable between a first position and a second position along an extension direction of the spindle relative to the magnetic force generation unit. The driven unit is provided with a second positioning portion. The second positioning portion is correspondingly engaged with the first positioning portion. When the driven unit is located at the first position, the second positioning portion is disengaged from the first positioning portion. When the magnetic force generation unit generates an attractive magnetic force, the magnetic force generation unit drives the driven unit to move toward the stop surface and to be located at the second position, the second positioning portion and the first positioning portion are engaged with each other, and the driven unit restricts a rotation of the spindle.

With the aforementioned design, during the process of tightening or loosening the workpiece through the power tool, the driven unit is located at the first position and could be driven by the spindle to rotate. When the power tool reaches the condition in which the torque is increased to the preset torque, the transmission unit stops the transmission. At that time, the magnetic force generation unit could generate the attractive magnetic force to drive the driven unit, and the driven unit is moved from the first position to the second position, so that the second positioning portion and the first positioning portion are engaged with each other, and the driven unit restricts the rotation of the spindle. In this way, the spindle stops rotating, thereby effectively reducing hand discomfort experienced by the user due to the reaction force during the high-torque phase.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the reverse torque suppression device for the power tool according to a first embodiment of the present invention;

FIG. 2 is an exploded view of the reverse torque suppression device for the power tool according to the first embodiment of the present invention;

FIG. 3 is a bottom view of the cover plate of the magnetic force generation unit according to the first embodiment of the present invention;

FIG. 4 is a top view of the metallic plate of the driven unit according to the first embodiment of the present invention;

FIG. 5 is a schematic view, showing that the driven unit according to the first embodiment of the present invention is located at the first position;

FIG. 6 is a schematic view, showing that the driven unit according to the first embodiment of the present invention is moved to the second position;

FIG. 7 is a schematic view of the reverse torque suppression device for the power tool according to a second embodiment of the present invention;

FIG. 8 is a perspective view of the reverse torque suppression device for the power tool according to a third embodiment of the present invention;

FIG. 9 is an exploded view of the reverse torque suppression device for the power tool according to the third embodiment of the present invention;

FIG. 10 is a side view, showing that the driven unit according to the third embodiment of the present invention is located at the first position; and

FIG. 11 is a side view, showing that the driven unit according to the third embodiment of the present invention is located at the second position.

### DETAILED DESCRIPTION OF THE INVENTION

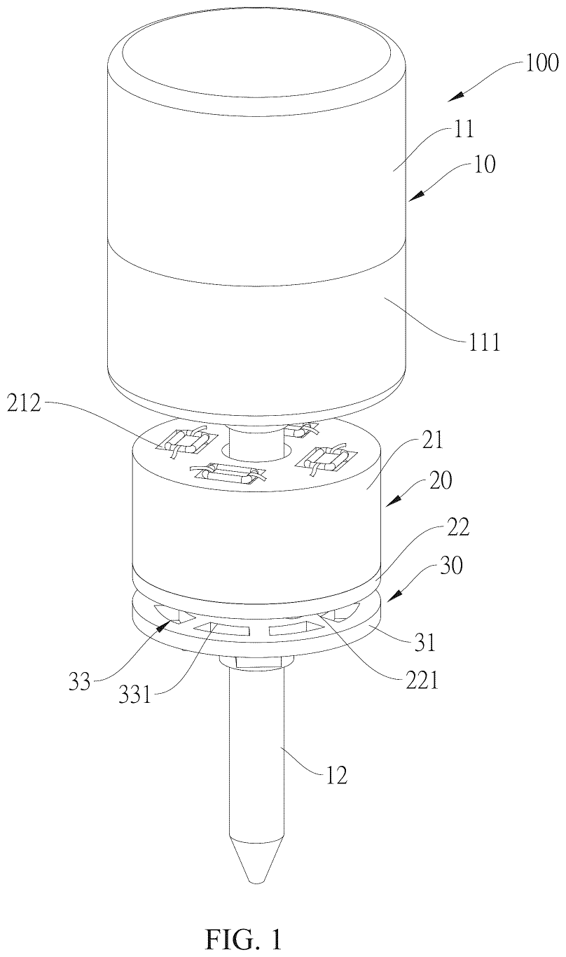

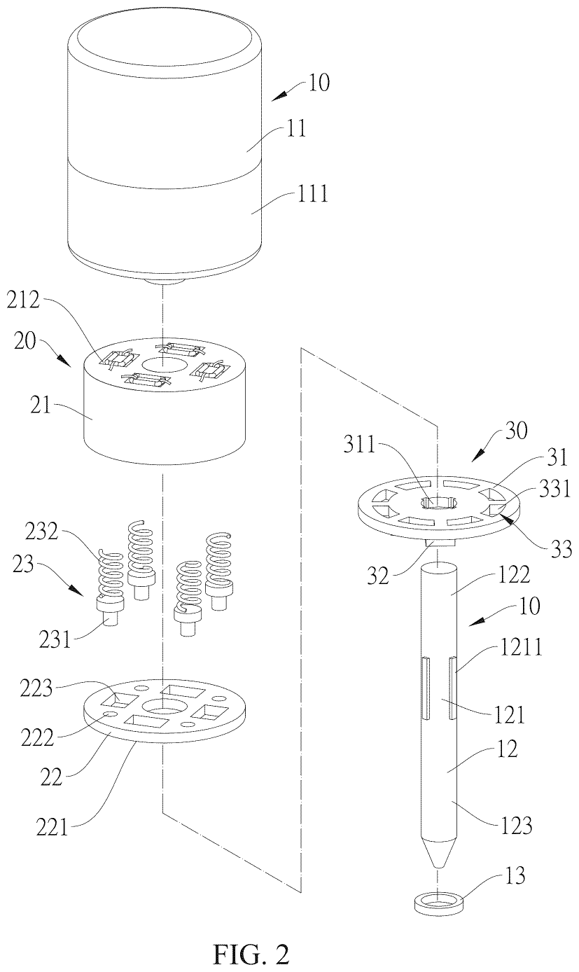

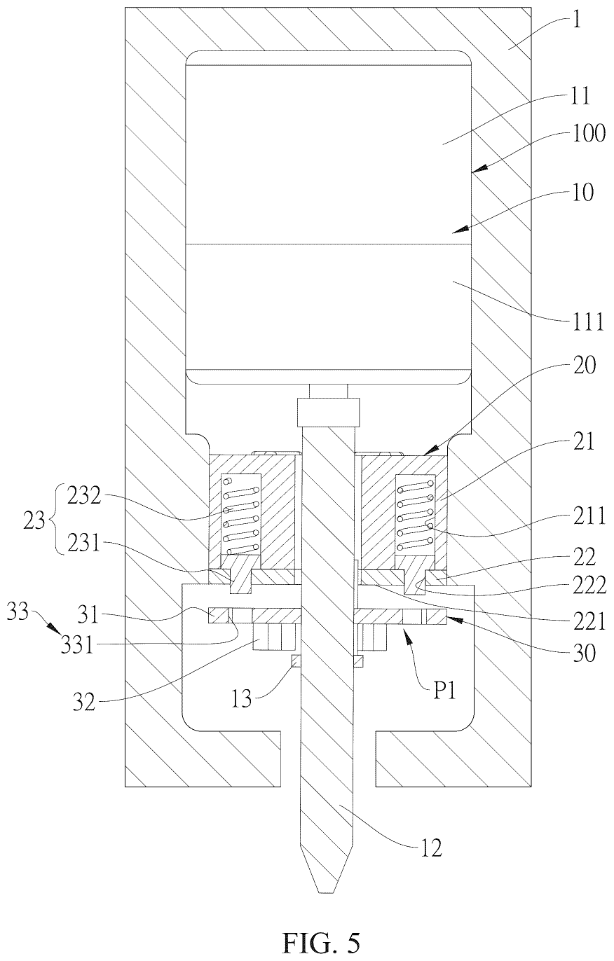

A reverse torque suppression device 100 for a power tool according to a first embodiment of the present invention is illustrated in FIG. 1, FIG. 2, and FIG. 5 and is configured to mount within a casing 1 of the power tool. The reverse torque suppression device 100 includes a transmission unit 10, a magnetic force generation unit 20, and a driven unit 30.

The transmission unit 10 has a motor 11 and a spindle 12. The motor 11 is fixed on the casing 1. The motor 11 is configured to drive the spindle 12 to rotate. Referring to FIG. 2 and FIG. 5, the motor 11 has a gear box 111 connected to the spindle 12. The spindle 12 has a sliding section 121, a first flat section 122, and a second flat section 123. The sliding section 121 is provided with a plurality of sliding blocks 1211 disposed around the spindle 12. The sliding blocks 1211 are disposed along an extension direction of the spindle 12. The first flat section 122 and the second flat section 123 are respectively located on two sides of the sliding section 121. Both the first flat section 122 and the second flat section 123 are flat surfaces of the spindle 12. The gear box 111 is rotatably connected to the first flat section 122. The motor 11 drives the spindle 12 to rotate through the gear box 111. The spindle 12 is provided with a blocking ring 13. The blocking ring 13 is fixed on the second flat section 123 and is adjacent to the sliding section 121.

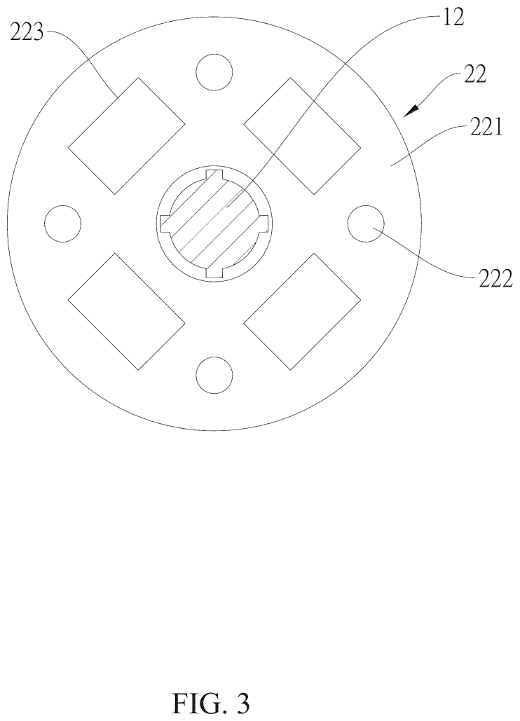

The magnetic force generation unit 20 passes through the spindle 12 of the transmission unit 10. In the first embodiment, the magnetic force generation unit 20 passes through the first flat section 122 of the spindle 12, and the magnetic force generation unit 20 is fixed on the casing 1, so that the spindle 12 rotates relative to the magnetic force generation unit 20. Referring to FIG. 2 and FIG. 5, the magnetic force generation unit 20 includes an electromagnetic coil assembly 21, a cover plate 22, and a first positioning portion 23. The electromagnetic coil assembly 21 is connected to a controller (not shown). The controller could control the electromagnetic coil assembly 21 to generate an attractive magnetic force and a repelling magnetic force. The electromagnetic coil assembly 21 has a plurality of receiving grooves 211 and a plurality of electromagnetic coils 212. The receiving grooves 211 are provided around the spindle 12. An opening of each of the receiving grooves 211 faces the sliding section 121 of the spindle 12. The electromagnetic coils 212 are disposed along the extension direction of the spindle 12 and are disposed around the spindle 12. Two ends of each of the electromagnetic coils 212 are respectively exposed on two sides of the electromagnetic coil assembly 21. The electromagnetic coils 212 could be connected in series or in parallel. The electromagnetic coils 212 could be controlled to generate the attractive magnetic force and the repelling magnetic force. The cover plate 22 is engaged with a side of the electromagnetic coil assembly 21. The cover plate 22 has a stop surface 221. The stop surface 221 faces the sliding section 121 of the spindle 12. Referring to FIG. 3 and FIG. 5, a plurality of through holes 222 and a plurality of electromagnetic holes 223 penetrate through the stop surface 221. A position of the through holes 222 corresponds to a position of the receiving grooves 211, and a position of the electromagnetic holes 223 corresponds to a position of the electromagnetic coils 212, so that an end of the electromagnetic coils 212 is exposed to the electromagnetic holes 223 of the stop surface 221 without being covered by the cover plate 22. The first positioning portion 23 is disposed between the electromagnetic coil assembly 21 and the cover plate 22. In the first embodiment, the first positioning portion 23 includes a plurality of posts 231 and a plurality of springs 232. The posts 231 and the springs 232 are received in the receiving grooves 211. The posts 231 are abutted by the springs 232 to protrude from the through holes 222, so that the posts 231 are exposed on the stop surface 221 of the cover plate 22 at a normal state, and the posts 231 could elastically retract into the stop surface 221 upon being pressed.

In other embodiments, the magnetic force generation unit 20 could be adjusted in terms of structure to meet different requirements. For example, the magnetic force generation unit 20 could be provided without the cover plate 22, and the first positioning portion 23 could be provided without the springs 232. In other words, the magnetic force generation unit 20 is provided with the stop surface 221, and the posts 231 of the first positioning portion 23 are fixedly disposed on the stop surface 221.

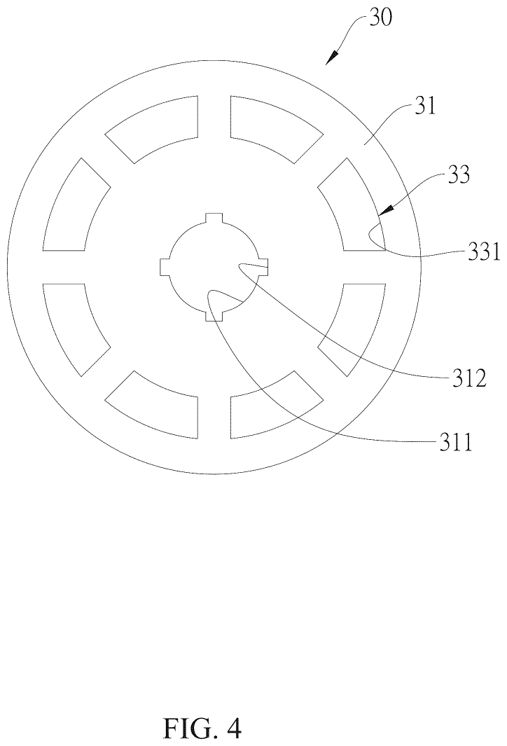

The driven unit 30 is fitted on the sliding section 121 of the spindle 12, and the driven unit 30 faces the stop surface 221 of the cover plate 22. The magnetic force generation unit 20 is located between the motor 11 and the driven unit 30. The driven unit 30 could be driven by the spindle 12 to rotate. The driven unit 30 is movable between a first position P1 and a second position P2 along the extension direction of the spindle 12 relative to the magnetic force generation unit 20, and the driven unit 30 is blocked by the magnetic force generation unit 20 and the blocking ring 13, so that the driven unit 30 could not be disengaged relative to the sliding section 121 of the spindle 12. Referring to FIG. 2, FIG. 4, and FIG. 5, in the first embodiment, the driven unit 30 includes a metallic plate 31, a magnet 32, and a second positioning portion 33. The metallic plate 31 is fitted on the sliding section 121 of the spindle 12. The metallic plate 31 could be driven by the attractive magnetic force of the magnetic force generation unit 20 to move toward the stop surface 221 of the cover plate 22. The metallic plate 31 has an axial hole 311. An inner edge of the axial hole 311 is provided with a plurality of recesses 312 matching with the sliding blocks 1211 of the sliding section 121. The magnet 32 and the second positioning portion 33 are respectively disposed on the metallic plate 31. The magnet 32 could be attracted or repelled by the electromagnetic coil assembly 21, so that the metallic plate 31 is movable between the first position P1 and the second position P2. The second positioning portion 33 is correspondingly engaged with the first positioning portion 23. The second positioning portion 33 is a plurality of restricting grooves 331; the restricting grooves 331 are disposed around the axial hole 311; a position of the restricting grooves 331 corresponds to the position of the posts 231, but not limited thereto. In other embodiments, the configuration of the first positioning portion 23 and the configuration of the second positioning portion 33 are exchangeable, as along as the first positioning portion 23 and the second positioning portion 33 could be engaged with each other.

Referring to FIG. 5, during a process in which a workpiece is tightened or loosened through the reverse torque suppression device 100, the driven unit 30 is initially located at the first position P1. A distance is provided between the metallic plate 31 of the driven unit 30 and the cover plate 22 of the magnetic force generation unit 20. The second positioning portion 33 of the driven unit 30 is disengaged from the first positioning portion 23 of the magnetic force generation unit 20. The motor 11 of the transmission unit 10 could drive the spindle 12 to rotate relative to the magnetic force generation unit 20, and the metallic plate 31 of the driven unit 30 rotates along with the spindle 12.

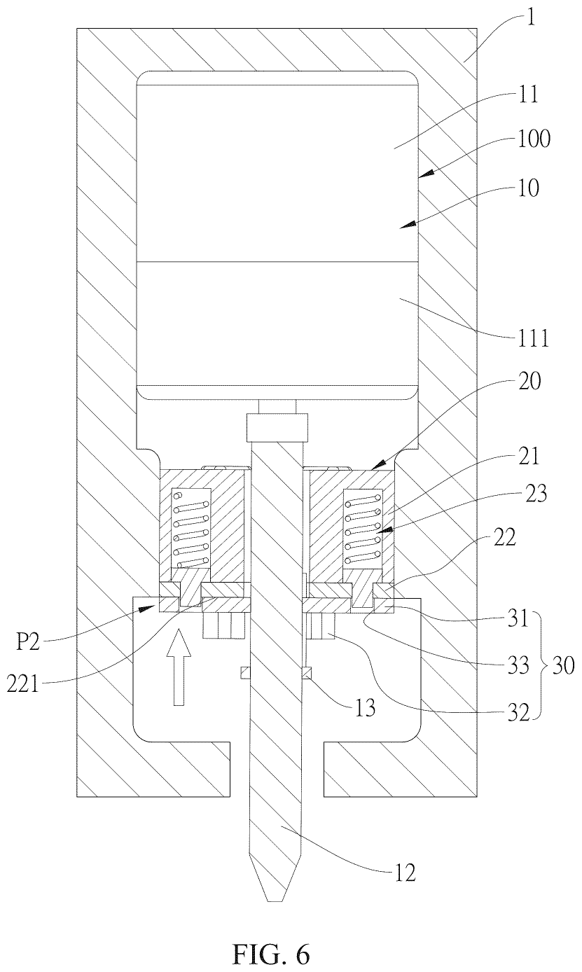

Referring to FIG. 6, when the reverse torque suppression device 100 reaches condition in which a torque is increased to a preset torque, the electromagnetic coils 212 of the electromagnetic coil assembly 21 are controlled to generate the attractive magnetic force, and the metallic plate 31 of the driven unit 30 and the magnet 32 are attracted by the electromagnetic coil assembly 21, so that the metallic plate 31 is driven by the electromagnetic coil assembly 21 to move upward and toward the stop surface 221 of the cover plate 22, and the driven unit 30 is moved from the first position P1 to the second position P2. At least one of the posts 231 of the first positioning portion 23 could be inserted into one of the restricting grooves 331 of the second positioning portion 33, so that the second positioning portion 33 and the first positioning portion 23 are engaged with each other. In this way, the second positioning portion 33 of the driven unit 30 is restricted by the first positioning portion 23 of the magnetic force generation unit 20 and stops rotating, and the driven unit 30 correspondingly restricts a rotation of the spindle 12, so that a rotational action force of the spindle 12 is offset, thereby reducing hand discomfort experienced by a user due to a reaction force during a high-torque phase.

Moreover, when the reverse torque suppression device is about to resume an operation of the transmission unit 10, the electromagnetic coil assembly 21 is switched from generating the attractive magnetic force to generating the repelling magnetic force. The magnet 32 of the driven unit 30 is repelled by the repelling magnetic force of the electromagnetic coil assembly 21, so that the magnet 32 drives the metallic plate 31 to move away from the cover plate 22, and the driven unit 30 is returned from the second position P2 to the first position P1. In this way, a restricting relationship between the first positioning portion 23 and the second positioning portion 33 is dismissed, so that a transmission operation of the transmission unit 10 is resumed.

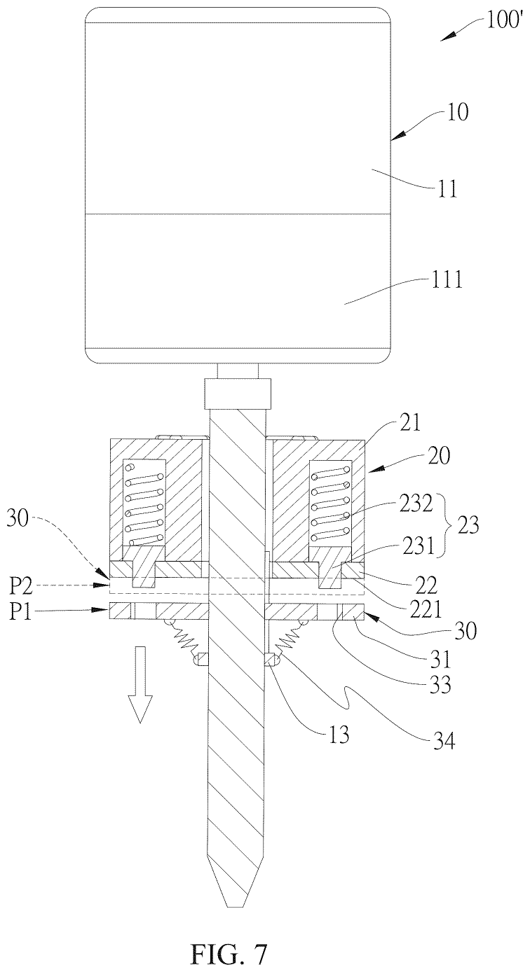

It is worth mentioning that the movement of the driven unit 30 returning from the second position P2 to the first position P1 is not limited to being caused by the repelling magnetic force generated by the electromagnetic coil assembly 21. For example, a reverse torque suppression device 100′ for the power tool 100 according to a second embodiment of the present invention is illustrated in FIG. 7 and includes the transmission unit 10, the magnetic force generation unit 20, and the driven unit 30. The structure of transmission unit 10, the magnetic force generation unit 20, and the driven unit 30 of the second embodiment is almost identical to that of the first embodiment. In the second embodiment, the magnet 32 of the driven unit 30 is replaced with an elastic member 34. The elastic member 34 is a tension spring. Two ends of the elastic member 34 are respectively connected to the metallic plate 31 and the blocking ring 13. The metallic plate 31 of the driven unit 30 is maintained at the first position P1 due to a pulling force of the elastic member 34. When the driven unit 30 is located at the second position P2, the elastic member 34 continuously pulls the metallic plate 31. When the electromagnetic coil assembly 21 stops the attractive magnetic force, the metallic plate 31 is moved away from the stop surface 221 of the cover plate 22 due to the pulling force of the elastic member 34, so that the driven unit 30 is returned from the second position P2 to the first position P1.

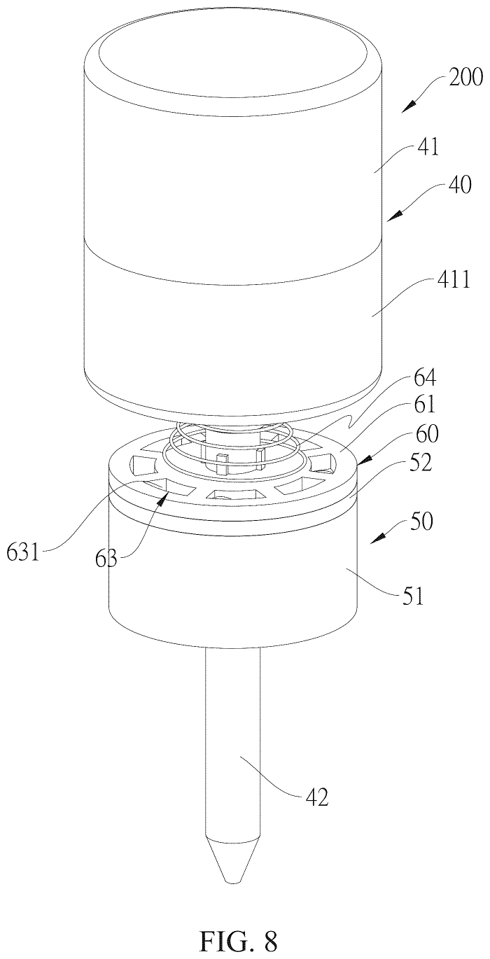

A reverse torque suppression device 200 for a power tool according to a third embodiment of the present invention is illustrated in FIG. 8 to FIG. 11 and includes a transmission unit 40, a magnetic force generation unit 50, and a driven unit 60.

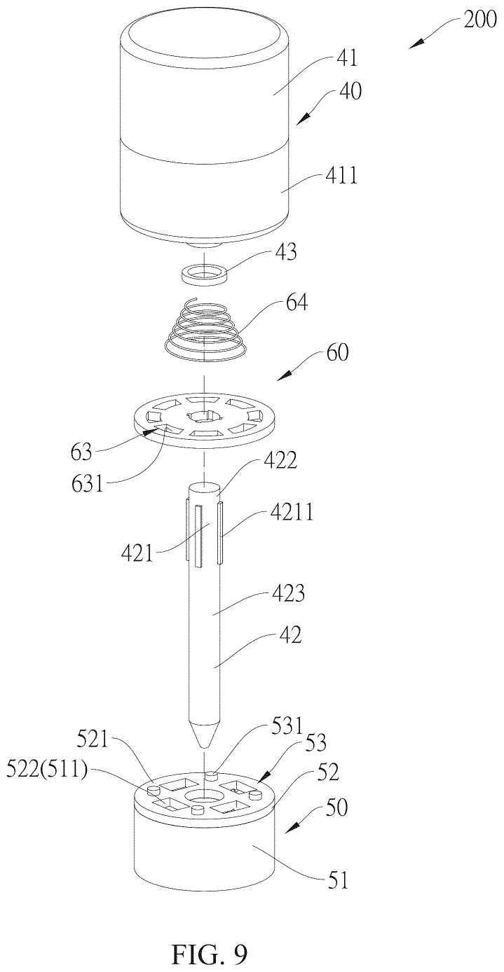

The transmission unit 40 has a motor 41 and a spindle 42. The motor 41 is configured to drive the spindle 42 to rotate. Referring to FIG. 9, the motor 41 has a gear box 411 connected to the spindle 42. The spindle 42 has a sliding section 421, a first flat section 422, and a second flat section 423. The sliding section 421 has a plurality of sliding blocks 4211 disposed around the spindle 42. The first flat section 422 and the second flat section 423 are respectively located on two sides of the sliding section 421. The gear box 411 is rotatably connected to the first flat section 422. The spindle 42 is provided with a blocking ring 43. The blocking ring 43 is fixed on the first flat section 422 and is adjacent to the motor 41.

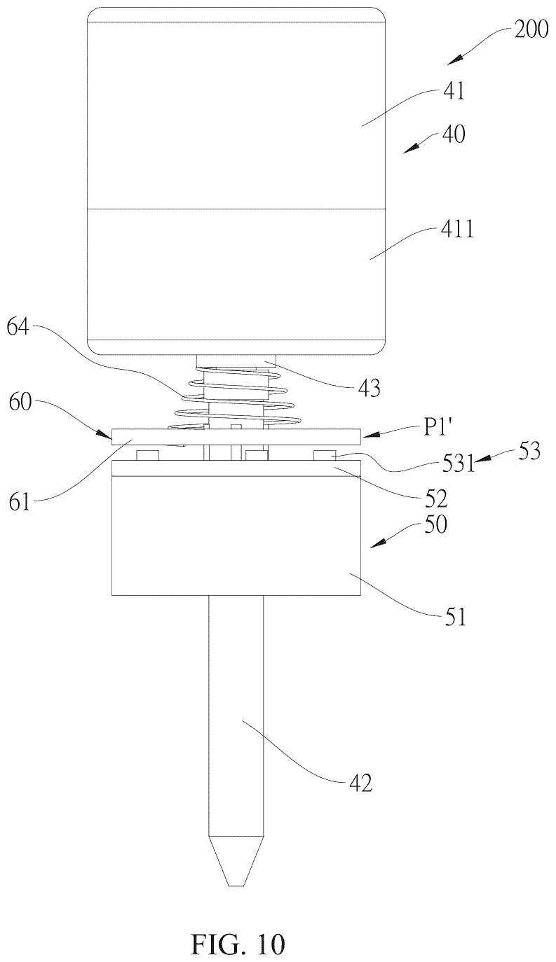

The magnetic force generation unit 50 passes through the spindle 42 of the transmission unit 40. The structure of the magnetic force generation unit 50 of the third embodiment is almost identical to that of the magnetic force generation unit 20 of the first embodiment. In the third embodiment, the magnetic force generation unit 50 passes through the second flat section 423 of the spindle 42, and the magnetic force generation unit 50 is fixed on a casing of the power tool (not shown). The spindle 42 is rotatable relative to the magnetic force generation unit 50. Referring to FIG. 9 and FIG. 10, the magnetic force generation unit 50 includes an electromagnetic coil assembly 51, a cover plate 52, and a first positioning portion 53. The electromagnetic coil assembly 51 has a plurality of electromagnetic coils 511. The electromagnetic coils 511 could generate an attractive magnetic force. The cover plate 52 is engaged with a side of the electromagnetic coil assembly 51. The cover plate 52 has a stop surface 521 facing the motor 41. A plurality of electromagnetic holes 522 penetrates through the stop surface 521. A position of the electromagnetic holes 522 corresponds to a position of the electromagnetic coils 511, so that an end of the electromagnetic coils 511 is exposed on the electromagnetic holes 522 of the stop surface 521 without being covered by the cover plate 52. The first positioning portion 53 is disposed between the electromagnetic coil assembly 51 and the cover plate 52. The first positioning portion 53 includes a plurality of posts 531. The posts 531 protrude from the stop surface 521 of the cover plate 52.

The driven unit 60 is fitted on the sliding section 421 of the spindle 42. The driven unit 60 faces the stop surface 521 of the cover plate 52. The driven unit 60 is located between the motor 41 and the magnetic force generation unit 50. The driven unit 60 could be driven by the spindle 42 to rotate. The driven unit 60 is movable between a first position P1′ and a second position P2′ along an extension direction of the spindle 42 relative to the magnetic force generation unit 50. The structure of the driven unit 60 of the third embodiment is almost identical to the structure of the driven unit 30 of the first embodiment. Referring to FIG. 9 and FIG. 10, in the third embodiment, the driven unit 60 includes a metallic plate 61, a second positioning portion 63, and an elastic member 64. The metallic plate 61 is fitted on the sliding section 421 of the spindle 42. The second positioning portion 63 is disposed on the metallic plate 61. The second positioning portion 63 is correspondingly engaged with the first positioning portion 53. The second positioning portion 63 is a plurality of restricting grooves 631. A position of the restricting grooves 631 corresponds to the position of the posts 531. Two ends of the elastic member 64 are respectively connected to the metallic plate 61 and the blocking ring 43. The metallic plate 61 is maintained at the first position P1′ due to a pulling force of the elastic member 64. At that time, a distance is provided between the metallic plate 61 of the driven unit 60 and the cover plate 52 of the magnetic force generation unit 50, and the second positioning portion 63 of the driven unit 60 is disengaged from the first positioning portion 53 of the magnetic force generation unit 50, so that the motor 41 of the transmission unit 40 could drive the spindle 42 to rotate.

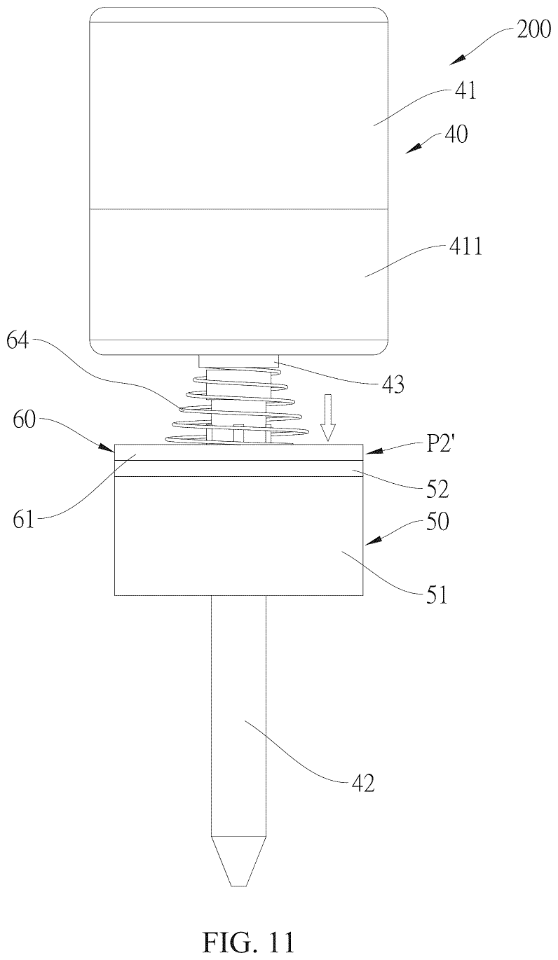

Referring to FIG. 9 and FIG. 11, when the reverse torque suppression device 200 reaches a condition in which a torque is increased to a preset torque, the electromagnetic coil assembly 51 is controlled to generate the attractive magnetic force. The metallic plate 61 could be driven by the electromagnetic coil assembly 51 to move downward and toward the stop surface 521 of the cover plate 52, and the driven unit 60 is moved from the first position P1′ to the second position P2′. The posts 531 of the first positioning portion 53 could be inserted into the restricting grooves 631 of the second positioning portion 63, so that the second positioning portion 63 and the first positioning portion 53 are engaged with each other. In this way, the driven unit 60 restricts a rotation of the spindle 42, thereby reducing hand discomfort experienced by a user due to a reaction force.

Moreover, when the reverse torque suppression device 200 is about to resume an operation of the transmission unit 40, the attractive magnetic force of the electromagnetic coil assembly 51 is stopped. The metallic plate 61 is moved away from the stop surface 521 of the cover plate 52 due to the pulling force of the elastic member 64, and the driven unit 60 is returned from the second position P2′ to the first position P1′. In this way, a restricting relationship between the first positioning portion 53 and the second positioning portion 63 is dismissed, so that a transmission operation of the transmission unit 40 could be resumed. In other embodiments, the elastic member 64 could be omitted, and the driven unit 60 could be provided with a magnet for replacing the elastic member 64. The magnet is disposed on the metallic plate 61. The electromagnetic coil assembly 51 could generate a repelling magnetic force. When the electromagnetic coil assembly 51 is switched from generating the attractive magnetic force to generating the repelling magnetic force, the magnet of the driven unit 60 is repelled by the repelling magnetic force of the electromagnetic coil assembly 51, so that the magnet drives the metallic plate 61 to move away from the cover plate 52, and the driven unit 60 could be returned to the first position P1′.

With the aforementioned design, during the process of tightening or loosening the workpiece through the power tool, when the torque is increased to the preset torque, the reverse torque suppression device 100, 200 for the power tool could drive the driven unit 30, 60 to move from the first position P1,P1′ to the second position P2, P2′ through the magnetic force generation unit 20, 50, and the second positioning portion 33, 63 and the first positioning portion 23, 53 are engaged with each other, so that the spindle 12, 42 is stopped from rotating, thereby effectively reducing hand discomfort experienced by the user due to the reaction force during the high-torque phase. When the reverse torque suppression device 100, 200 for the power tool is about to resume the operation of the transmission unit 10, 40, the driven unit 30, 60 could be controlled to move away from the magnetic force generation unit 20, 50, so that the restricting relationship between the first positioning portion 23,53 and the second positioning portion 33, 63 is dismissed. In this way, the driven unit 30, 60 could be returned from the second position P2, P2′ to the first position P1, P1′, so that the transmission operation of the transmission unit 10, 40 is resumed.

It must be pointed out that the embodiments described above are only some preferred embodiments of the present invention. All equivalent structures which employ the concepts disclosed in this specification and the appended claims should fall within the scope of the present invention.

What is claimed is:

1. A reverse torque suppression device for a power tool, comprising:
a transmission unit having a spindle, wherein the spindle is provided with a sliding section;
a magnetic force generation unit passing through the spindle, wherein the spindle is rotatable relative to the magnetic force generation unit, the magnetic force generation unit has a stop surface, and the stop surface is provided with a first positioning portion; and
a driven unit fitted on the sliding section of the spindle and facing the stop surface of the magnetic force generation unit, wherein the driven unit is capable of being driven by the spindle to rotate, the driven unit is movable between a first position and a second position along an extension direction of the spindle relative to the magnetic force generation unit, and the driven unit comprises a second positioning portion;
wherein when the driven unit is located at the first position, the second positioning portion is disengaged from the first positioning portion; when the magnetic force generation unit generates an attractive magnetic force, the magnetic force generation unit drives the driven unit to move toward the stop surface and to be located at the second position, the second positioning portion and the first positioning portion are engaged with each other, and the driven unit restricts a rotation of the spindle.

2. The reverse torque suppression device as claimed in claim 1, wherein the magnetic force generation unit is switchable to generate a repelling magnetic force; the driven unit comprises a metallic plate and a magnet; the metallic plate is fitted on the sliding section and is capable of being driven by the attractive magnetic force of the magnetic force generation unit to move toward the stop surface; the magnet and the second positioning portion are disposed on the metallic plate; when the magnetic force generation unit is switched from generating the attractive magnetic force to generating the repelling magnetic force, the magnet of the driven unit is repelled by the repelling magnetic force of the magnetic force generation unit, and the driven unit is returned from the second position to the first position.

3. The reverse torque suppression device as claimed in claim 1, wherein the transmission unit has a motor; the motor drives the spindle to rotate; the spindle has a first flat section and a second flat section; the first flat section and the second flat section are respectively located on two sides of the sliding section; the motor is rotatably connected to the first flat section; the magnetic force generation unit passes through the first flat section and is located between the motor and the driven unit.

4. The reverse torque suppression device as claimed in claim 3, wherein the spindle is provided with a blocking ring; the blocking ring is fixed on the second flat section; the driven unit comprises a metallic plate and an elastic member; the metallic plate is fitted on the sliding section and is capable of being driven by the attractive magnetic force of the magnetic force generation unit to move toward the stop surface; the second positioning portion is disposed on the metallic plate; two ends of the elastic member are respectively connected to the metallic plate and the blocking ring; when the magnetic force generation unit stops generating the attractive magnetic force, the metallic plate is moved away from the stop surface due to a pulling force of the elastic member, and the driven unit is returned from the second position to the first position.

5. The reverse torque suppression device as claimed in claim 1, wherein the transmission unit has a motor; the motor drives the spindle to rotate; the spindle has a first flat section and a second flat section; the first flat section and the second flat section are respectively located on two sides of the sliding section; the motor is rotatably connected to the first flat section; the magnetic force generation unit passes through the second flat section; the driven unit is located between the motor and the magnetic force generation unit.

6. The reverse torque suppression device as claimed in claim 5, wherein the spindle is provided with a blocking ring; the blocking ring is fixed on the first flat section; the driven unit comprises a metallic plate and an elastic member; the metallic plate is fitted on the sliding section and is capable of being driven by the attractive magnetic force of the magnetic force generation unit to move toward the stop surface; the second positioning portion is disposed on the metallic plate; two ends of the elastic member are respectively connected to the metallic plate and the blocking ring; when the magnetic force generation unit stops generating the attractive magnetic force, the metallic plate is moved away from the stop surface due to a pulling force of the elastic member, and the driven unit is returned from the second position to the first position.

7. The reverse torque suppression device as claimed in claim 1, wherein the first positioning portion has a plurality of posts; the plurality of posts protrude from the stop surface; the second positioning portion has a plurality of restricting grooves; when the driven unit is located at the second position, at least one of the plurality of posts is inserted into one of the plurality of restricting grooves.

8. The reverse torque suppression device as claimed in claim 7, wherein the magnetic force generation unit has an electromagnetic coil assembly and a cover plate; the electromagnetic coil assembly has a plurality of receiving grooves; the first positioning portion has a plurality of springs; the plurality of springs and the plurality of posts are received in the plurality of receiving grooves; the cover plate is engaged with a side of the electromagnetic coil assembly and closes the plurality of receiving grooves; the cover plate has the stop surface; the stop surface is provided with a plurality of through holes; a position of the plurality of through holes corresponds to a position of the plurality of receiving grooves; the plurality of posts are abutted by the plurality of springs to protrude from the plurality of through holes.

9. The reverse torque suppression device as claimed in claim 7, wherein the driven unit has an axial hole; the plurality of restricting grooves are disposed around the axial hole; the sliding section is provided with a plurality of sliding blocks disposed around the spindle; an inner edge of the axial hole is provided with a plurality of recesses matching with the plurality of sliding blocks.
